(19) United States
(12) Patent Application Publication
(10) Pub. No.: US 2014/0089392 A1
(43) Pub. Date: Mar. 27, 2014

(54) VIRTUAL MACHINE STOCK MANAGEMENT SYSTEM AND METHOD

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHIU-HUA LU, New Taipei (TW); HO-I SUN, New Taipei (TW)

(21) Appl. No.: 13/924,643

(22) Filed: Jun. 24, 2013

(30) Foreign Application Priority Data
Sep. 25, 2012 (TW) 101135137

(51) Int. Cl. H04L 12/24

(52) U.S. Cl. CPC H04L 41/0803
USPC 709/203; 709/220; 709/221

(57) ABSTRACT

A cloud server stocks a plurality of virtual machines (VMs) with different configuration specifications, assigns one or more VMs with one configuration specification to a client when a request is received for assigning VMs to the client, and updates a stock of the VMs with the configuration specification. When a stock of the VMs with the configuration specification is less than a preset stock threshold, the cloud server supplements the VMs with the configuration specification.

### BACKGROUND

1. Technical Field

Embodiments of the present disclosure relate to cloud computing technology, and more particularly to virtual machine stock management system and method.

2. Description of Related Art

Virtual machines (VM) are software implementations that create one or more VMs on an operating system (kernel) layer of a server. A guest operating system (OS) is a virtualized environment, and by installing a guest OS in the VMs, multiple guest OS can co-exist and run independently on the same server, so that resources (e.g., such as CPU resource, hard disk resource) of the server can serve more clients. Often, the server provides the VMs to a client in such a manner: the client logs onto the server and selects configuration parameters (such as specifications of the OS, CPU, memory, and hard disk resources) of desired VMs, the server dynamically configures the desired VMs according to the configuration parameters, and assigns the configured VMs to the client. In such a manner, the client may need to wait a time for the desired VMs.

### BRIEF DESCRIPTION OF THE DRAWINGS

FIG. 1 is a block diagram of one embodiment of an application environment of a virtual machine (VM) stock management system.

FIG. 2 is a block diagram of one embodiment of function modules of the VM stock management system in FIG. 1.

FIG. 3 is a flowchart of one embodiment of a VM stock management method.

FIG. 4 is a chart showing VMs with different hardware specifications.

FIG. 5 is a chart showing VMs with different configuration specifications and stock information.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

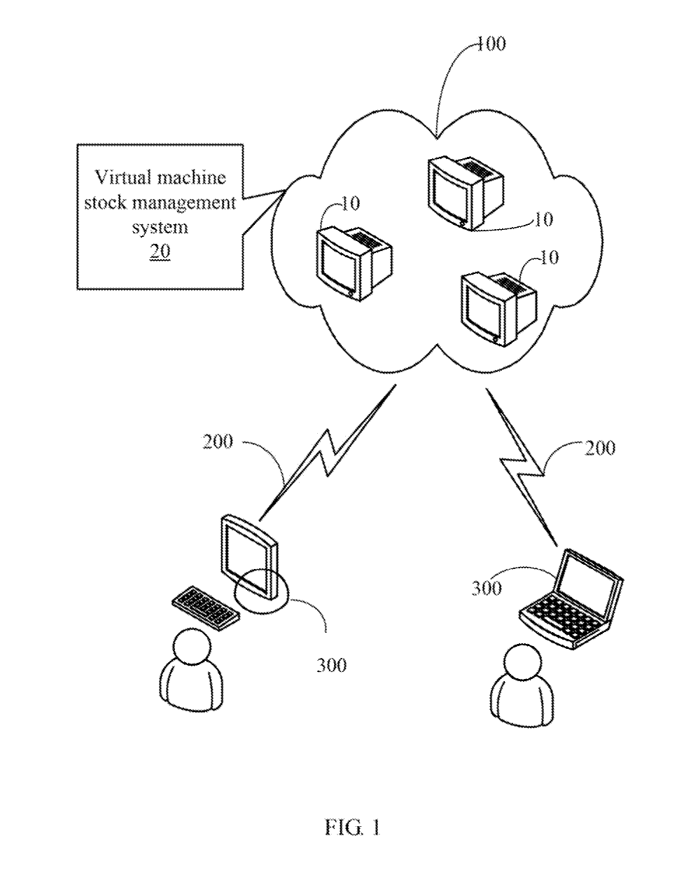

FIG. 1 is a block diagram of one embodiment of an application environment of a virtual machine (VM) stock management system 20 (hereinafter the “system 20”). In one embodiment, the system 20 is applied in a cloud server 100. The cloud server 100 may be a single server or a server cluster consisting of a plurality of servers. One or more clients 300 (two are shown) are connected to the cloud server 100 via a network 200. The cloud server 100 stocks a number of VMs 10 with different configuration specifications, and assigns one or more desired VMs 10 to the clients 300 when receives requests of assigning VMs 10 from the one or more clients 300. The system 20 monitors stocks of the VMs 10 with different configuration specifications, and when detecting that the cloud server 100 is short of stock of VMs 10 with any configuration specification, the system 20 notifies the cloud server 100 to supplement the stock.

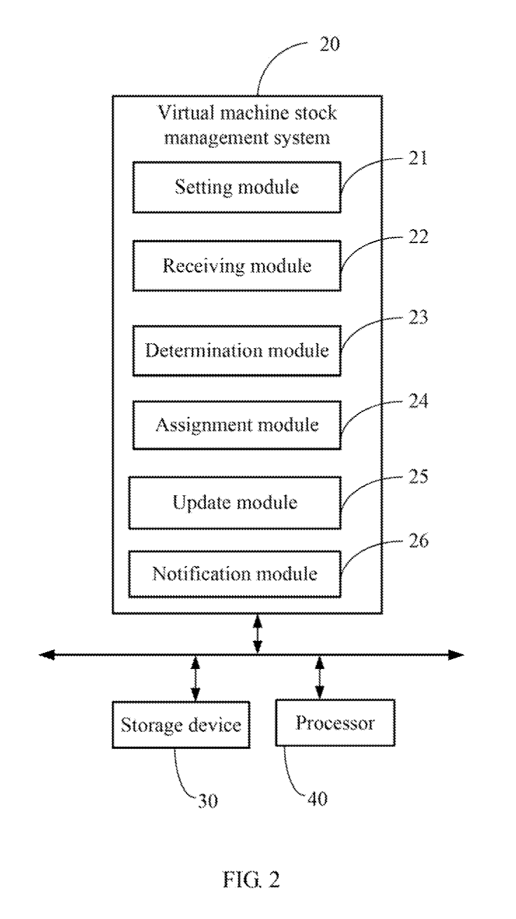

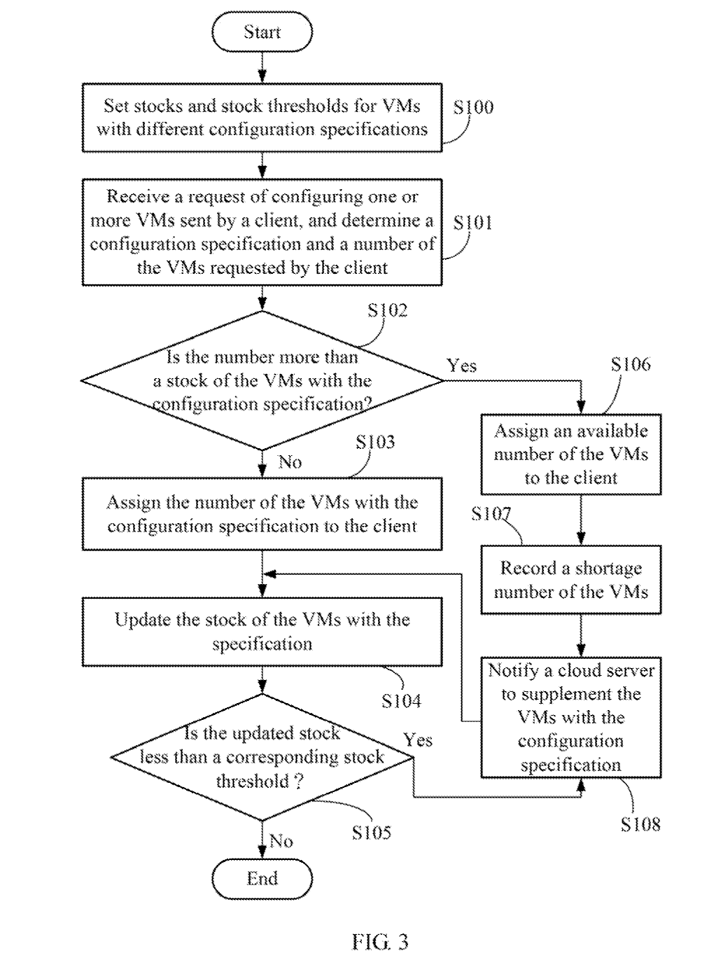

As shown in FIG. 2, the system 20 includes a plurality of function modules, such as a setting module 21, a receiving module 22, a determination module 23, an assignment module 24, an update module 25, and a notification module 26. The modules 21-26 include computerized code in the form of one or more programs that are stored in a non-transitory storage device 30 of the cloud server 100. The storage device 30 is a dedicated memory, such as an EPROM, a hard disk driver (HDD), or flash memory. The computerized code includes instructions that are executed by at least one processor 40 of the cloud server 100, to provide aforementioned functions of the system 20. Detailed functions of the modules 21-26 are given in reference to FIG. 3.

FIG. 3 is a flowchart of one embodiment of a VM stock management method. Depending on the embodiment, additional steps may be added, others removed, and the ordering of the steps may be changed. For example, the method may just include steps S100, S107, S109, and S115.

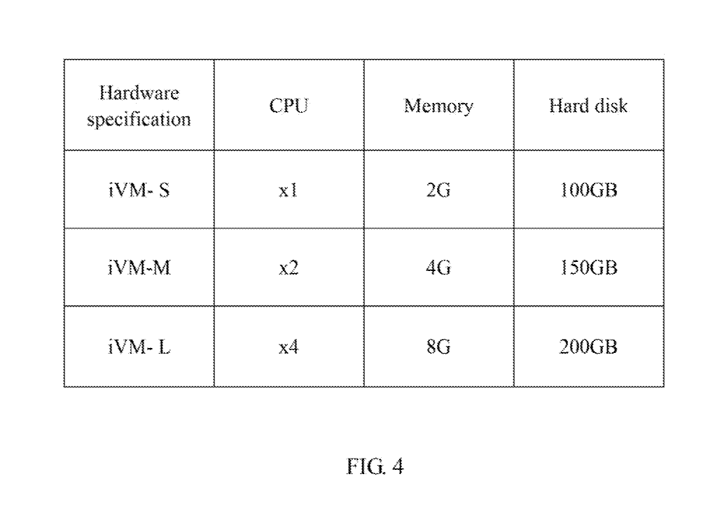

In step S100, the setting module 21 sets stocks and stock thresholds for VMs 10 with different configuration specifications. In one example, the cloud server 100 may provide four different types of operating systems, such as “OS₁”, “OS₂”, “OS₃”, and “OS₄”, and provides three different types of hardware specifications, such as “iVM-S”, “iVM-M”, and “iVM-L”. As shown in FIG. 4, the hardware specification of “iVM-S” represents a VM 10 is configured with 1 CPU, 2G memory, and 100G hard disk, the hardware specification of “iVM-M” represents a VM 10 is configured with 2 CPUs, 4G memory, and 150G hard disk, and hardware specification of “iVM-L” represents a VM 10 is configured with 4 CPUs, 8G memory, and 200G hard disk.

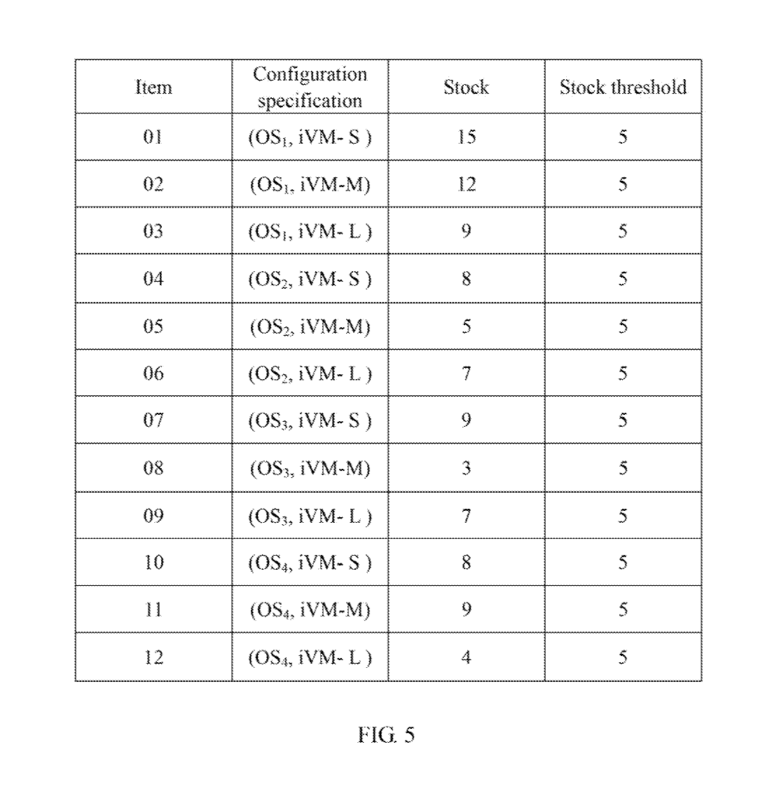

As shown in FIG. 5, the cloud server 100 can provide VMs 10 with twelve different configuration specifications, and the setting module 21 sets a stock and a stock threshold for VMs 10 of each configuration specification. The stock of the VMs 10 of one configuration specification indicates a number of VMs 10 with the configuration specification is configured and kept on hand by the cloud server 100. When a client 300 request the VMs 10 of the configuration specification, the cloud server 100 assigns the VMs 10 to the client 300, so that the client 300 does not need to wait a long time. The stock threshold indicates a minimal number of the VMs 10 of the configuration specification that the cloud server 100 should keep on hand. In this embodiment, the VMs of different configuration specifications may be set to have the same stock and stock threshold, or have different stocks and stocks thresholds.

In step S101, the receiving module 22 receives a request of configuring one or more VMs 10 sent by a client 300, and determines a configuration specification and a number of the VMs 10 requested by the client 300 according to the request. For example, the client 300 may requests four VMs 10 with the configuration specification “(OS₂, iVM-M).”

In step S102, the determination module 23 determines if the number of the VMs 10 requested by the client 300 is more than a stock of the VMs 10 with the configuration specification. If the number of the VMs 10 requested by the client 300 is less than or equal to the stock of the VMs 10 with the configuration specification, step S105 is implemented. Otherwise, if the number of the VMs 10 requested by the client 300 is more than the stock of the

VMs 10 with the configuration specification, step S111 is implemented.

In step S 103, the assignment module 24 assigns the number of VMs 10 with the configuration specification to the client 300. For example, if the cloud server 100 stock five VMs 10 with the configuration specification “(OS₂, iVM-M),” and the number requested by the client 300 request is four, then the assignment module 24 assigns four VMs 10 with the configuration specification “(OS₂, iVM-M)” to the client 300.

In step S104, the update module 25 updates the stock of the VMs 10 with the configuration specification. For example, the stock of the VMs 10 with the configuration specification “(OS₂, iVM-M)” is updated from five to one after four VMs 10 have been assigned to the client 300.

In step S105, the determination module 23 determines if the updated stock of the VMs 10 with the configuration specification is less than a stock threshold of the VMs 10 with the configuration specification. If the updated stock is less than the stock threshold of the VMs 10 with the configuration specification, step S108 is implemented. For example, as shown in FIG. 5, the stock threshold of the VMs 10 with the configuration specification “(OS₂, iVM-M)” is five, and the updated stock is one, then step S108 is implemented.

In step S108, the notification module 26 notifies the cloud server 100 to supplement the VMs 10 with the configuration specification. For example, the notification module 26 may notify a manager of the cloud server 100 to add four VMs 10 with the configuration specification “(OS₂, iVM-M).” In one example, the notification module 26 may send an email to an email box of the manager. Then, the procedure returns to step S104.

In step S103, if the number of the VMs 10 requested by the client 300 is more than the stock of the VMs 10 with the configuration specification, the procedure goes to step S106, the assignment module 24 an available number of the VMs 10 with the configuration specification to the client 300. For example, if the client 300 may requests six VMs 10 with the configuration specification “(OS₂, iVM-M),” and the stock is five, then the assignment module 24 assigns five VMs 10 with the configuration specification “(OS₂, iVM-M)” to the client 300. Then, step S107 is implemented, the assignment module 24 records shortage information of the requested VMs 10. The shortage information includes a shortage number of the VMs 10 that should be assigned to the client 300. For example, the assignment module 24 may record shortage information as follows: “the VMs 10 with the configuration specification “(OS₂, iVM-M) has zero stock, the stock threshold is five, and the client 300 still requests one, please configure at least six VMs 10 with the configuration specification!” Then, the procedure goes to step S 108. After the cloud server 100 supplementing the stock, the assignment module 24 further assigns the shortage number of the VMs 10 to the client 300.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a cloud server, the method comprising:
setting stocks and stock thresholds for virtual machines (VMs) with different configuration specifications in the cloud server; and
notifying the cloud server to supplement a stock of the VMs with one configuration specification when the stock of the VMs with the configuration specification is less than a corresponding stock threshold.

2. The method of claim 1, further comprising:
receiving a request of assigning a number of the VMs with the configuration specification sent by a client; and
assigning the number of the VMs with the configuration specification to the client when the stock of the VMs with the configuration specification is more than or equal to the number, or assigning an available number of the VMs with the configuration specification to the client when the stock of the VMs with the configuration specification is less than the number, and recording a shortage number of the VMs that should be assigned to the client.

3. The method of claim 2, further comprising:
notifying the cloud server to supplement the VMs with the configuration specification when the stock of the VMs with the configuration specification is less than the number; and
assigning the shortage number of the VMs with the configuration specification to the client.

4. The method of claim 2, further comprising:
updating the stock of the VMs with the configuration specification after assigning the VMs with the configuration specification to the client.

5. The method of claim 1, wherein the configuration specification of a VM comprises information in relation to an operating system, a CPU resource, a memory resource, and a hard disk resource of the VM.

6. A cloud server, comprising:
at least one processor; and
a storage device storing one or more programs, when executed by the at least one processor, cause the at least one processor to perform operations of:
setting stocks and stock thresholds for virtual machines (VMs) with different configuration specifications in the cloud server; and
notifying the cloud server to supplement a stock of the VMs with one configuration specification when the stock of the VMs with the configuration specification is less than a corresponding stock threshold.

7. The device of claim 6, wherein the operations further comprise:
receiving a request of assigning a number of the VMs with the configuration specification sent by a client; and
assigning the number of the VMs with the configuration specification to the client when the stock of the VMs with the configuration specification is more than or equal to the number, or assigning an available number of the VMs with the configuration specification to the client when the stock of the VMs with the configuration specification is less than the number, and recording a shortage number of the VMs that should be assigned to the client.

8. The device of claim 7, wherein the operations further comprise:
notifying the cloud server to supplement the VMs with the configuration specification when the stock of the VMs with the configuration specification is less than the number; and
assigning the shortage number of the VMs with the configuration specification to the client.

9. The device of claim 7, wherein the operations further comprise:
updating the stock of the VMs with the configuration specification after assigning the VMs with the configuration specification to the client.

10. The device of claim 6, wherein the configuration specification of a VM comprises information in relation to an operating system, a CPU resource, a memory resource, and a hard disk resource of the VM.

11. A non-transitory computer-readable medium having stored thereon instructions that, when executed by at least one processor of a cloud server, cause the at least one processor to perform operations of:
setting stocks and stock thresholds for virtual machines (VMs) with different configuration specifications in the cloud server; and
notifying the cloud server to supplement a stock of the VMs with one configuration specification when the stock of the VMs with the configuration specification is less than a corresponding stock threshold.

12. The medium of claim 11, wherein the operations further comprise:
receiving a request of assigning a number of the VMs with the configuration specification sent by a client; and
assigning the number of the VMs with the configuration specification to the client when the stock of the VMs with the configuration specification is more than or equal to the number, or assigning an available number of the VMs with the configuration specification to the client when the stock of the VMs with the configuration specification is less than the number, and recording a shortage number of the VMs that should be assigned to the client.

13. The medium of claim 12, wherein the operations further comprise:
notifying the cloud server to supplement the VMs with the configuration specification when the stock of the VMs with the configuration specification is less than the number; and
assigning the shortage number of the VMs with the configuration specification to the client.

14. The medium of claim 12, wherein the operations further comprise:
updating the stock of the VMs with the configuration specification after assigning the VMs with the configuration specification to the client.

15. The medium of claim 11, wherein the configuration specification of a VM comprises information in relation to an operating system, a CPU resource, a memory resource, and a hard disk resource of the VM.
